(19) United States
(12) Patent Application Publication
(10) Pub. No.: US 2005/0076765 A1
(43) Pub. Date: Apr. 14, 2005

(54) Recessed tuning machine for stringed instrument

(76) Inventor: Anthony M. Morris, Indianapolis, IN (US)

Correspondence Address: BAKER & DANIELS, 300 NORTH MERIDIAN STREET, SUITE 2700, INDIANAPOLIS, IN, 46204-1782, US

(21) Appl. No.: 10/684,895

(22) Filed: Oct. 14, 2003

(51) Int. Cl. G10D 3/14

(52) U.S. Cl. 84/312 R

(57) ABSTRACT

The present invention involves a stringed musical instrument, such as a guitar or the like, with a body, a head attached to the body, a string having a first end attached to the body and a second end, and a tuning machine mounted within the head and attached to the second end of the string. The tuning machine includes a recessed actuation element that may be a hexagonally shaped recess, a straight screw driver head shaped slot, or a Phillips head shaped slot. The tuning machine also includes reduction gearing which may advantageously have a ratio of at least 15:1, possibly at least 30:1. The tuning machine comprises a tuning peg adapted to receive a string of a musical instrument and reduction gearing actuable through an access aperture in the body of the tuning peg. A guitar reconstruction kit is also included for retrofitting, including a tuning machine having a tuning machine body comprising a tuning peg adapted to receive a string of a musical instrument and reduction gearing accessible through an access aperture in the body for the tuning peg, and a tool having a tool head compatible with the access aperture.

### BACKGROUND OF THE INVENTION

1. Field of the Invention

The present invention generally relates to stringed instruments such as guitars, both acoustic and electric, electric bass guitars, mandolins, banjos, and other such stringed musical instruments. More specifically, the present invention relates to tuning machines for such stringed instruments.

2. Description of the Related Art

The use of stringed instruments for the production of music has long existed. The musician plucks, strums, or otherwise causes the string to vibrate and create a musical note. To have a string produce a particular note, the string must have a particular distance and tightness on the stringed instrument. To allow the musician to adjust the tuning on a stringed instrument, tuning machines have been developed, for example those using reduction gearing to turn a peg which tightens or loosens a particular string.

Typically, musicians will tune each string of a musical instrument prior to playing the instrument, and often frequently during the musical session. The precise tuning is important because notes should be accurately reproduced, and the quality of a musical performance is often judged by how the notes sound together. Generally, two different notes are ascetically pleasing only if their frequencies are simple integer fraction multiples of each other, so that even minor tuning inaccuracies can lead to unpleasant musical performance. Thus, most tuning machines on one end of a musical instrument have tuning keys which extend from the tuning machines. By rotation of the tuning keys, often in the form of wing nut type of physical structures, the musician can quickly and easily adjust the length and tension on the string, and correspondingly the note which the string renders when played.

There are several disadvantages from the present arrangement of tuning keys and tuning machines. For one, precise tuning of the strings can often be difficult and time consuming, which then requires frequent tuning by the musician. This frequent tuning is caused by the likelihood that during a musical performance, the tuning keys will be slightly moved or jarred, and correspondingly the related peg will move slightly and unintentionally change the tension and length of the string. Another consequence of this frequent tuning is that the strings tend to be subject to more wear because of the frequent tuning, so that the life of the string is diminished. Finally, if a tuning key is sufficiently disturbed, it may break off or otherwise detach from the tuning machine, rendering the tuning machine useless.

### SUMMARY OF THE INVENTION

The present invention provides a recessed tuning machine for a string instrument activated by an internal interface to provide for precise tuning without having an outwardly extending tuning key for disrupting the set tension and length of the corresponding string. With the present invention, a simple tool which engages the tuning machine is used, such as a hexagonal recess and a hexagonal projection in an Allen wrench like arrangement. Alternatively, a screw or Phillips head screw arrangement may also be used.

The present invention may be used in the production of new stringed instruments, for example guitars. Alternatively, replacement recessed tuning machines may be used to retrofit existing instruments, for example mounting in place of existing tuning machine. By using recessed tuning machines, the strings will tend to stay in tune longer thus enhancing the life of the strings. In addition, musicians may then spend less time tuning and more time playing.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a top planned view of an electric guitar construction according to the present invention.

FIG. 2 is a perspective view of an acoustic guitar with the recessed tuning machine of the present invention.

FIG. 3 is a side sectional view of the guitar head having a retrofitted tuning machine constructed according to the present invention.

FIG. 4 is a bottom planned of the head of FIG. 3.

FIG. 5 is a side sectional view of a third embodiment of the tuning machine of the present invention.

FIG. 6 is a back plan view of the embodiment of FIG. 5.

FIGS. 7-9 are perspective views of three tuning tools for the present invention.

FIG. 10 shows a side sectional view of tuning machine gearing of the present invention.

FIG. 11 shows a side sectional view taken along view lines 11-11 of FIG. 10.

FIG. 12 shows a bottom sectional view taken along view lines 12-12 of FIG. 11.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings. For example, although the exemplary embodiments show guitars, other stringed musical instruments may utilize this invention. Examples include, but not limited to, mandolins, banjos, and the like.

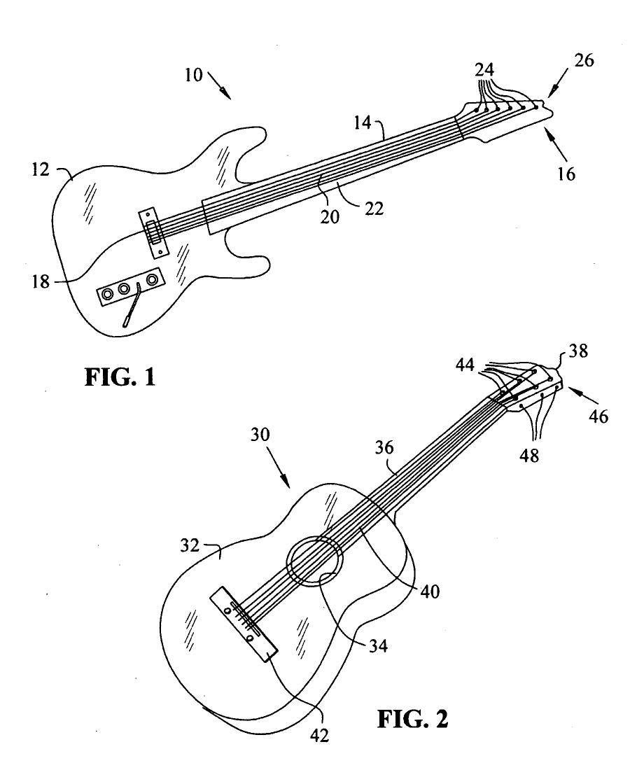

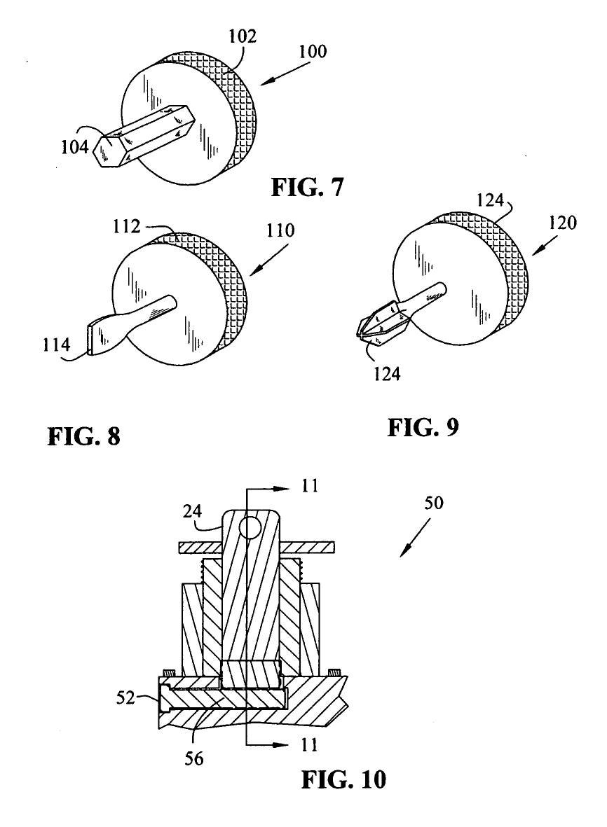

FIG. 1 depicts electric guitar 10 having body 12, neck 14, and head 16. Bridge 18 anchors a plurality of strings 20 on body 12. Strings 20 extend across neck 14, over fingerboard 22 having a plurality of frets (now shown). Strings 20 extend up to respective turning pegs 24, which are part of tuning machine 26. Strings 20 are attached at one end to respective turning pegs 24 in a conventional arrangement. In accordance with the present invention, the particular construction of tuning machine 26 does not have an outwardly extending tuning key. Instead, the tuning machine 26, in the embodiment shown in FIG. 1, is interregnally disposed within head 16 which serves as the body of turning machine 26. Turning machine 26 is actuated by an element within head 16, which is accessed by a tool described in greater detail below in regards to FIGS. 7 through 9.

In a second embodiment of the present invention shown in FIG. 2, acoustic guitar 30 includes body 32 having sound hole 34. Neck 36 extends from body 32 into head 38. Acoustic guitar 30 has a plurality of strings 40 which extend from bridge 42 mounted on body 32 to tuning pegs 44 on head 38. Pegs 44 are part of recessed tuning machine 46 which are accessible through access apertures 48.

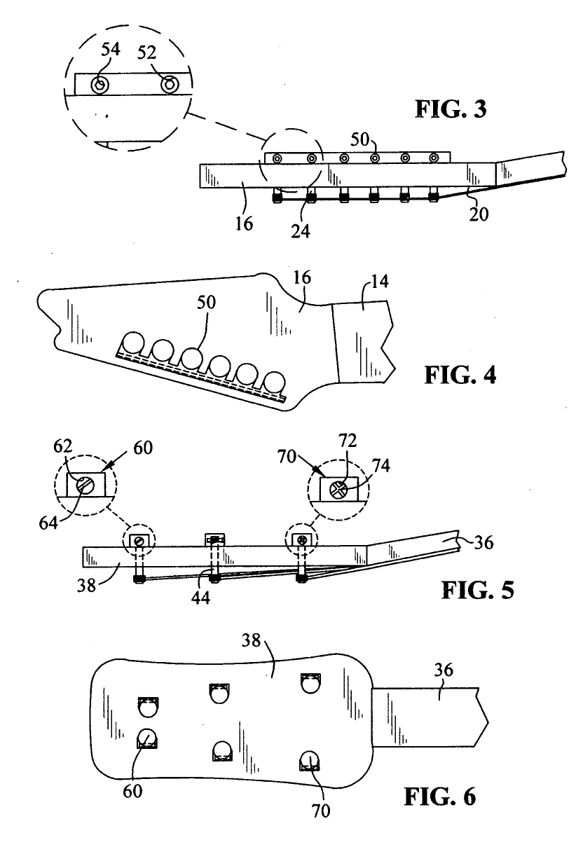

While FIGS. 1 and 2 show recessed tuning machines 26 and 46 which are formed within heads 16 and 38, the recessed tuning machine of the present invention may be retrofitted on existing instruments as depicted in FIGS. 3 through 6. For example, tuning machine 50 shown in FIGS. 3 and 4 provides a series of access holes 52 which include a hexagonally shaped recess 54 so that a Allen wrench type tool may actuate tuning machine 50 for the particular tuning peg 24.

An alternative embodiment shown in FIGS. 5 and 6 provides individual tuning machine retrofits. For example, one tuning peg 44 is incorporated in tuning machine 60, which provides a gear reduction through access aperture 62 and straight screw head shaped slot 64. Similarly, another tuning peg 44 is associated with tuning machine 70 having an access aperture 72 and Phillips head shaped slot 74.

To actuate tuning machines 26, 46, 50, 60, and 70 a tuning tool is useful. FIGS. 7-9 show alternative tools for three of the possible recessed tuning machine configurations. Tool 100 of FIG. 7 has handle 102 in the form of a hand grippable disc, with tool head 104 having the form of a hexagonal solid, namely an Allen wrench head. FIG. 8 depicts tool 110 with a hand grippable disc handle 112 and a screw driver head 114. FIG. 9 depicts tool 120 with a hand grippable disc handle 124 and a Phillips head screw driver 124.

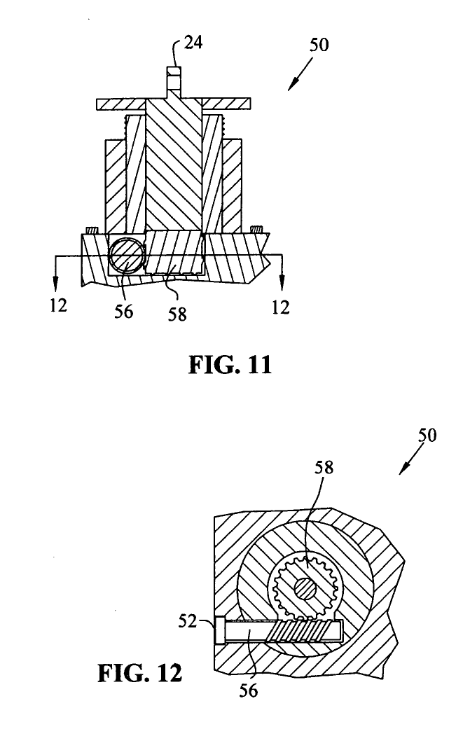

Each of the tools 100, 110, and 120 are adapted to allow manual manipulation of a corresponding tuning machine with a complementary recess or slot. In FIGS. 10-12, the inner mechanisms of tuning machine 50 is shown with recess 54 to accept tool 100, but slots for screw drivers and Phillips head screw drivers are also contemplated.

FIGS. 10-12 shows tuning machine 50 which rotationally couples tuning peg 24 with reduction gearing which is exemplary of a tuning machine of the present invention. Recess aperture 52 is formed in screw gear 56. Rotation of screw gear 56 causes the rotational engagement of sun gear 58 disposed at the bottom of peg 24. A string connected to the upper portion of peg 24 in a conventional manner may then be tightened or loosened by rotation of screw gear 56. Tool 100 may be positioned in recessed aperture 52 to drive screw gear 56.

Typical tuning machines use gear ratios in the range of 10:1 to 14:1. Although the present invention works with such an arrangement, further improvement may be obtained by using a higher gear ratio, such as over 15:1 or as much as 30:1. Also, the reduction gearing of FIGS. 10-12 is one exemplary embodiment of several types of gearings, where beveled or transverse gears may alternatively be used.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A stringed musical instrument comprising:
a body;
a head attached to said body;
a string having a first end attached to said body and a second end; and
a tuning machine mounted within said head and attached to said aecond end of said string.

2. The instrument of claim 1 wherein said tuning machine includes a recessed actuation element.

3. The instrument of claim 2 wherein said recessed actuation element includes a hexagonally shaped recess.

4. The instrument of claim 2 wherein said recessed actuation element includes a straight screw driver head shaped slot.

5. The instrument of claim 2 wherein said recessed actuation element includes a Phillips head shaped slot.

6. The instrument of claim 1 wherein said tuning machine includes reduction gearing.

7. The instrument of claim 6 wherein said reduction gearing has a ratio of at least 15:1.

8. The instrument of claim 6 wherein said gearing has a ratio of at least 30:1.

9. The instrument of claim 1 wherein said body includes a guitar body.

10. A tuning machine comprising:
a body;
a tuning peg adapted to receive a string of a musical instrument; and
reduction gearing actuable through an access aperture in said body.

11. The tuning machine of claim 9 wherein said access aperture includes a hexagonally shaped recess.

12. The tuning machine of claim 9 wherein said access aperture includes a straight screw head shaped slot.

13. The tuning machine of claim 9 wherein said access aperture includes a Phillips head shaped slot.

14. The tuning machine of claim 9 wherein said reduction gearing has a ratio of at least 15:1.

15. The tuning machine of claim 9 wherein said reduction gearing has a ratio of at least 30:1.

16. A guitar reconstruction kit including a tuning machine having a tuning machine body comprising:
a tuning peg adapted to receive a string of a musical instrument; and
reduction gearing accessible through an access aperture in said body for said tuning peg; and
a tool having a tool head compatible with said access aperture.

17. The kit of claim 16 wherein said access aperture includes a hexagonally shaped recess.

18. The kit of claim 16 wherein said access aperture includes a hexagonally shaped straight screw head shaped slot.

19. The kit of claim 16 wherein said access aperture includes a hexagonally shaped Phillips head shaped slot.

20. The kit of claim 16 wherein said access aperture includes a hexagonally shaped Phillips head shaped slot wherein said reduction gearing has a ratio of at least 15:1.

21. The kit of claim 16 wherein said access aperture includes a hexagonally shaped Phillips head shaped slot wherein said reduction gearing has a ratio of at least 30:1.

22. A tuning machine for a stringed musical instrument comprising:
a body;
means for securing one end of a string of a stringed musical instrument, said securing means extending from said body; and
means for turning said securing means positioned within said body, said turning means having an actuating element contained within said body.
